(19) United States
(12) Patent Application Publication
(10) Pub. No.: US 2018/0238319 A1
(43) Pub. Date: Aug. 23, 2018

(54) PIEZOELECTRIC FAN DRIVING DEVICE

(71) Applicant: Hao LEE, New Taipei City (TW)

(72) Inventor: Hao LEE, New Taipei City (TW)

(21) Appl. No.: 15/439,925

(22) Filed: Feb. 22, 2017

(51) Int. Cl. F04B 45/04; F04B 45/047; F04B 53/10; H02N 2/06

(52) U.S. Cl. CPC F04B 45/041; H02N 2/06; F04B 53/10; F04B 45/047

(57) ABSTRACT

The invention relates to a piezoelectric fan driving device comprising: a piezoelectric fan and a driving unit, wherein the piezoelectric fan comprises a connecting piece, two piezoelectric elements and at least one one-way air flowing piece. The connecting piece has an opening and two end surfaces. The two piezoelectric elements are fixed on the two end surfaces, and the connecting piece and two piezoelectric elements surround to form a cavity, one of the two piezoelectric elements having a through hole connecting to the cavity. The one-way air flowing piece connects the through hole. The driving unit electrically connects with the two piezoelectric elements to convert a DC power to an AC power, and the two piezoelectric elements are driven by the AC power.

### BACKGROUND OF THE INVENTION

### Field of the Invention

The invention relates to a driving device, particularly a piezoelectric fan driving device which is used to drive a piezoelectric fan by converting DC power into AC power.

### Description of the Related Art

In recent years, due to the rapid development of electronic products, the function of electronic components becomes more powerful, and the size of electronic components is gradually reduced and thus heat produced from an electronic component per unit area becomes more and more. Traditional thermal dissipation solution is the use of heat pipes matching the cooling fins or uniform temperature plate, or cooling fins matching the rotating fan to exhaust heat to outside for the purpose of cooling.

However, with mobile device such as smartphone and tablet computer pursuing thin type and high-effect, the effect of traditional heat pipes, uniform temperature plates or the rotating fans are not enough. Therefore, a new piezoelectric type radiator with thickness only 3 mm-4 mm is shown in the market that is more suitable to install in thin type mobile devices than a heat pipe or a rotating fan.

A piezoelectric type radiator mainly includes a connecting piece and two piezoelectric elements fixed on two sides of the connecting piece. A cavity is formed between the connecting piece and the two piezoelectric elements. The piezoelectric element may produce deformation by applying an electric field. A repeated action of the expansion and compression of internal volume of the cavity is produced to suck a cold air from outside and exhaust hot air out of the piezoelectric type radiator for the purpose of cooling.

However, the above-mentioned piezoelectric type radiator has the disadvantage as follow. The connecting piece has an opening connecting to the cavity. Because the piezoelectric type radiator sucks a cold air from outside and exhausts hot air through the same opening, the cold air and the hot air are easily mixing in the cavity so that the hot air cannot completely be exhausted out of the cavity and the cold air cannot flow into the cavity smoothly, and thus lowering the cooling efficiency of the piezoelectric type radiator.

Also, as the traditional piezoelectric type radiator integrated with an electronic device, the piezoelectric element may need an AC power to drive and produce vibration. Because most of the electronic devices only provide a DC power, and the DC power cannot drive the piezoelectric element, it is required to provide an additional device for producing a driving signal to drive the piezoelectric element, and thus the problem of integrated design of the electronic device and piezoelectric heat radiator is produced.

### SUMMARY OF THE INVENTION

One object of the present invention is to provide a piezoelectric fan driving device with a through hole provided on a membrane or a piezoelectric sheet of a piezoelectric element. A cold air can flow into the cavity smoothly from an opening and a hot air can be exhausted from a one-way air flowing piece on the through hole to avoid the cold air mixing with the hot air in the cavity for enhancing dissipation.

Another object of the present invention is to provide a piezoelectric fan driving device with a driving unit which can directly convert a DC power provided from an electronic device to an AC power for driving the piezoelectric element to solve the problem of integrated design of the electronic device and piezoelectric heat radiator.

In order to achieve the above-described object, the present invention provides a piezoelectric fan driving device comprising: a piezoelectric fan and a driving unit, wherein the piezoelectric fan comprises a connecting piece, two piezoelectric elements and at least one one-way air flowing piece. The connecting piece has an opening and two end surfaces. The two piezoelectric elements are fixed on the two end surfaces, and the connecting piece and two piezoelectric elements surround to form a cavity, one of the two piezoelectric elements having a through hole connecting to the cavity. The one-way air flowing piece connects the through hole. The driving unit electrically connects with the two piezoelectric elements to convert a DC power to an AC power, and the two piezoelectric elements are driven by the AC power.

In an aspect of the invention, the one-way air flowing piece is a one-way limiting diaphragm. The one-way air flowing piece is a one-way valve. Each the two piezoelectric elements comprises a membrane and a piezoelectric sheet, wherein the membrane is fixed on the two end surfaces of the connecting piece, and the piezoelectric sheet is fixed on a central position of the membrane, and the through hole is provided on the membrane or the piezoelectric sheet. The membrane is made of metallic sheet or plastic sheet. The connecting piece has a horizontal rod and two vertical rods extending from two ends of the horizontal rod, and the opening is formed between the two vertical rods, and the two end surfaces are respectively formed on an upper surface and a lower surface of the horizontal rod and the two vertical rods.

In an aspect of the invention, the connecting piece is U-shape. The connecting piece is a compressive elastomer. The connecting piece is made of rubber or silicone material. The connecting piece has a recess toward inside between the two end surfaces, and the recess has a thickness less than a thickness of the connecting piece. The connecting piece decreases a thickness gradually from two end surfaces to the recess so that the connecting piece has a section being V-shape or U-shape.

In an aspect of the invention, the driving unit comprises: a power converter for converting the DC power into AC power; and a power amplifier connecting with the power converter and two piezoelectric elements, amplifying the AC power output from the power converter to drive the two piezoelectric elements.

### BRIEF DESCRIPTION OF THE DRAWINGS

FIG. 1 shows an exploded view of a piezoelectric fan driving device of a first embodiment of the invention.

FIG. 2 shows an assembly view of a piezoelectric fan driving device of a first embodiment of the invention.

FIG. 3 shows a circuit block diagram of a piezoelectric fan driving device of a first embodiment of the invention.

FIG. 4 shows a view of wave form of DC power input.

FIG. 5 shows a view of wave form of AC power output.

FIG. 6 shows a side sectional view of a piezoelectric fan driving device of a first embodiment of the invention.

FIG. 7 shows an operative side sectional view of a piezoelectric fan driving device of a first embodiment of the invention.

FIG. 8 shows an assembly view of a piezoelectric fan driving device of a second embodiment of the invention.

FIG. 9 shows an assembly view of a piezoelectric fan driving device of a third embodiment of the invention.

### DESCRIPTION OF THE EMBODIMENTS

The features of the invention believed to be novel are set forth with particularity in the appended claims. The invention itself, however, may be best understood by reference to the following detailed description of the invention, which describes exemplary embodiments of the invention, taken in conjunction with the accompanying drawings.

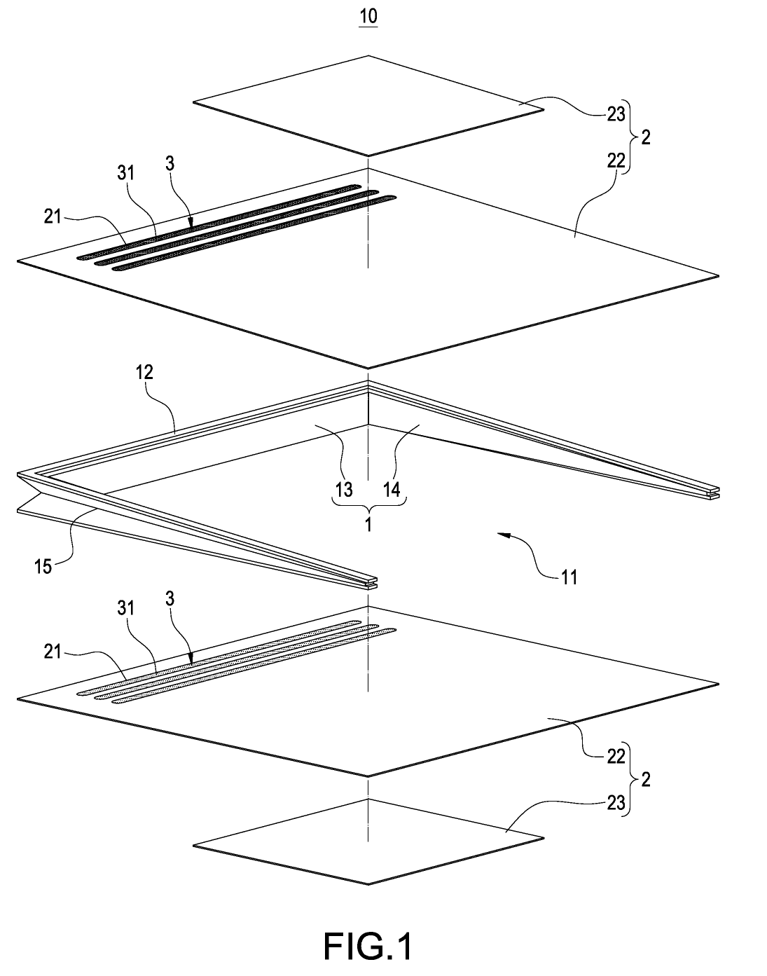

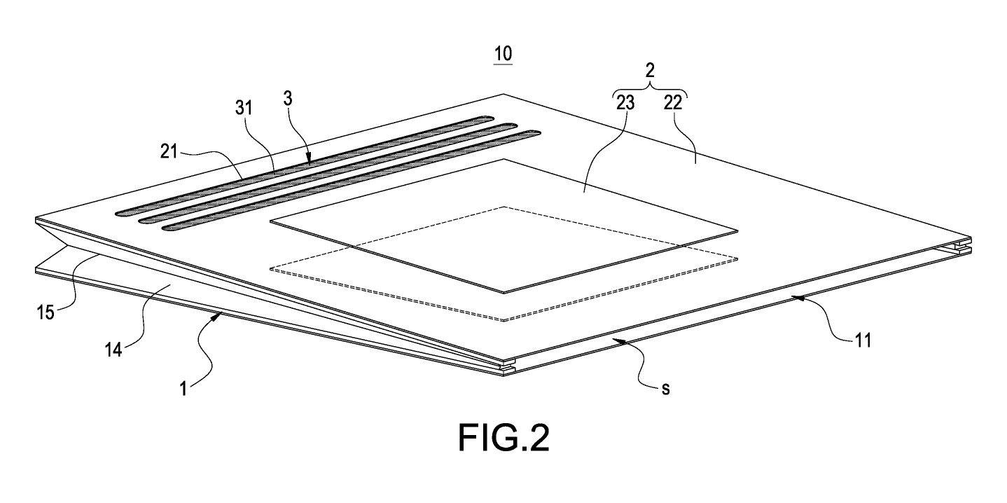

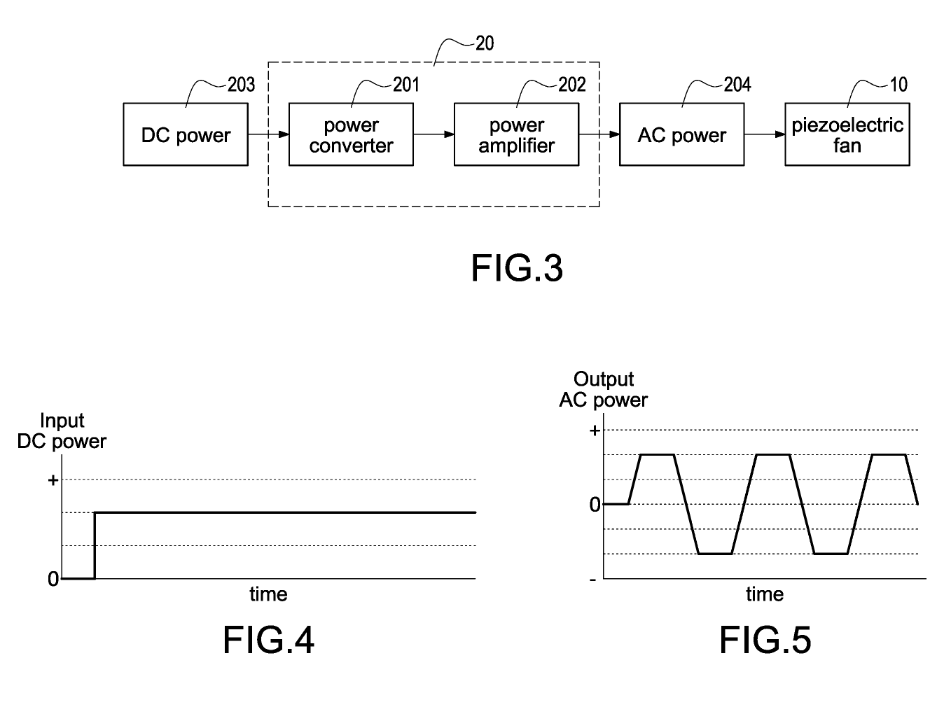

FIG. 1 shows an exploded view of a piezoelectric fan driving device of a first embodiment of the invention. FIG. 2 shows an assembly view of a piezoelectric fan driving device of a first embodiment of the invention. FIG. 3 shows a circuit block diagram of a piezoelectric fan driving device of a first embodiment of the invention. As shown in FIG. 3, a piezoelectric fan driving device of a first embodiment includes a piezoelectric fan 10 and a driving unit 20, wherein a DC power is inputted into the driving unit 20, and the DC power is converted into AC power to drive the piezoelectric fan 10.

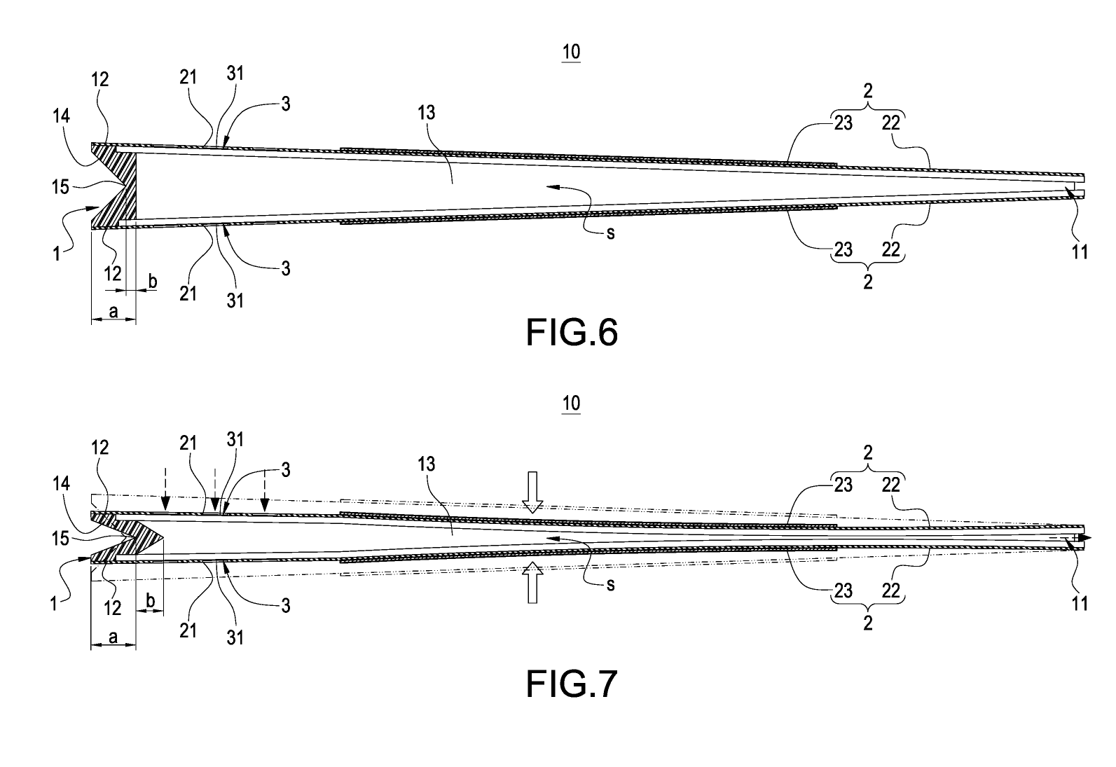

The piezoelectric fan 10 includes a connecting piece 1, two piezoelectric elements 2, 2 and at least one one-way air flowing piece 3. The connecting piece 1 is U-shape, and has an opening 11 thereon and two end surfaces 12, 12. The connecting piece 1 has a horizontal rod 13 and two vertical rods 14, 14 extending from two ends of the horizontal rod 13. The opening 11 is formed between the two vertical rods 14, 14, and the two end surfaces 12, 12 are respectively formed on an upper surface and a lower surface of the horizontal rod 13 and the two vertical rods 14, 14. In addition, the connecting piece 1 is made of rubber or silicone material so that the connecting piece 1 is a compressive elastomer. Alternatively, the connecting piece 1 has a recess 15 between two end surfaces 12, 12. As shown in FIG. 6, the recess 15 has a thickness b less than a thickness a of the connecting piece 1, when the connecting piece 1 is compressed, the connecting piece 1 can be easily compressed toward a direction of the recess 15. In case that the connecting piece 1 has the recess 15, the connecting piece 1 decreases a thickness gradually from two end surfaces 12, 12 to the recess 15 so that the connecting piece 1 has a section being V-shape or U-shape.

The two piezoelectric elements 2, 2 have been fixed on the two end surfaces 12, 12 of the connecting piece 1, and the connecting piece 1 and two piezoelectric elements 2, 2 surround to form a cavity s. Each the two piezoelectric elements 2, 2 comprises a membrane 22 and a piezoelectric sheet 23, wherein the membrane 22 is fixed on the two end surfaces 12, 12 of the connecting piece 1, and the piezoelectric sheet 23 is fixed on a central position of the membrane 22, and the membrane 22 provides at least one through hole 21 connecting to the cavity s, but actually, it would be fine as long as one membrane 22 has the through hole 21. In the FIG. 6, the membrane 22 is made of metallic sheet or plastic sheet.

The one-way air flowing piece 3 covers on the through hole 21. The one-way air flowing piece 3 is a one-way limiting diaphragm 31 to provide air from external environment into the cavity s by the through hole 21, and limit air flowing to external environment from the through hole 21 by the through hole 21; alternatively, the one-way limiting diaphragm 31 may exhaust air from cavity s to external environment by the through hole 21, and limit air flowing into the through hole 21 from external environment by the through hole 21.

The driving unit 20 electrically connects with the two piezoelectric sheets 23, 23. After the driving unit 20 is inputted with DC power, the DC power is converted into or simulated into AC power, and the AC power drives the two piezoelectric sheets 23, 23 to vibrate for bring a resonance of the membrane 22 so that the air may flow into the cavity s and exhaust from the opening 11 by the one-way air flowing piece 3.

FIG. 3 shows a circuit block diagram of a piezoelectric fan driving device of a first embodiment of the invention. FIG. 4 shows a view of wave form of DC power input. FIG. 5 shows a view of wave form of AC power output. As shown in FIG. 3, the driving unit 20 of the invention includes a power converter 201 and a power amplifier 202.

As shown in FIG. 4, as DC power 203 is inputted the power converter 201, the power converter 201 converts the DC power 203 into AC power output, and the converted AC power is amplified to a required AC power 204, and the amplified AC power 204 is used to drive the piezoelectric fan 10.

FIG. 6 shows a side sectional view of a piezoelectric fan driving device of a first embodiment of the invention. FIG. 7 shows an operative side sectional view of a piezoelectric fan driving device of a first embodiment of the invention. As the piezoelectric fan driving device of the first embodiment electrically connects an electronic device (not shown), the electronic device provides DC power, and the DC power is converted into AC power 204 by the driving unit 20 to drive the piezoelectric fan 10.

The two piezoelectric sheets 23, 23 of the piezoelectric fan 10 may produce vibration by applying AC power. As two piezoelectric sheets 23, 23 produce vibration, the two membranes 22, 22 are brought to produce vibration, a repeated action of the expansion and compression of internal volume of the cavity s is produced to suck a cold air from outside through the opening 11 and exhaust air out of the piezoelectric fan 10 from the through hole 21 by the one-way air flowing piece 3. The heat inside the electronic device can be dissipated effectively by a repeated action of the two piezoelectric sheets 23, 23 of the piezoelectric fan 10.

Because a cold air can flow into the cavity s smoothly from the opening 11, and a hot air can be exhausted from the one-way air flowing piece 3 on the through hole 21. The inflow of cold air and the discharge of hot air use different paths to avoid the cold air mixing with the hot air in the cavity s for enhancing dissipation.

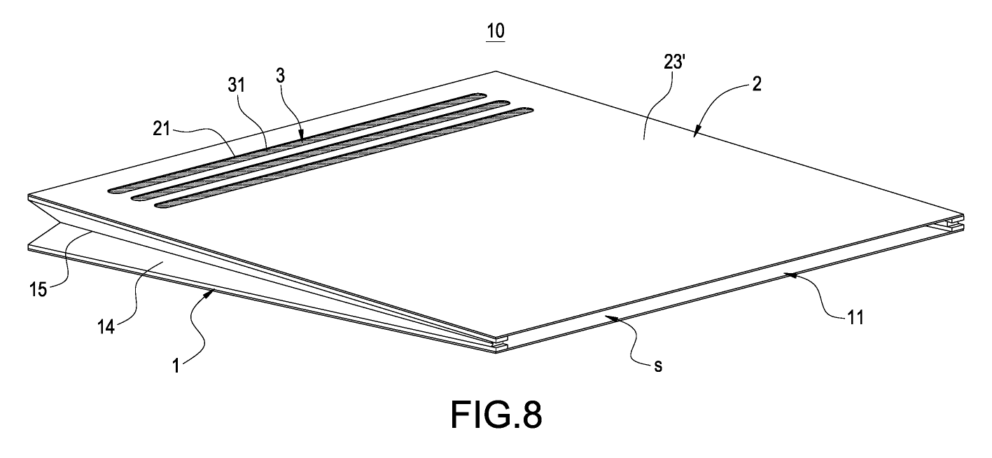

FIG. 8 shows an assembly view of a piezoelectric fan driving device of a second embodiment of the invention. As shown in FIG. 8, the structure of the second embodiment is similar to that of the first embodiment. The difference between the second embodiment and the first embodiment is that the one-way air flowing piece 3 is circular one-way valve 32. The air may flow into the cavity s by circular one-way valve 32 through the through hole 21. As two piezoelectric sheets 23, 23 produce vibration, and the two membranes 22, 22 are brought to produce vibration, the external air may flow into the cavity s through the through hole 21, and the air may be exhausted out of the piezoelectric fan 10 from the opening 11 so that the heat inside the electronic device can be dissipated effectively.

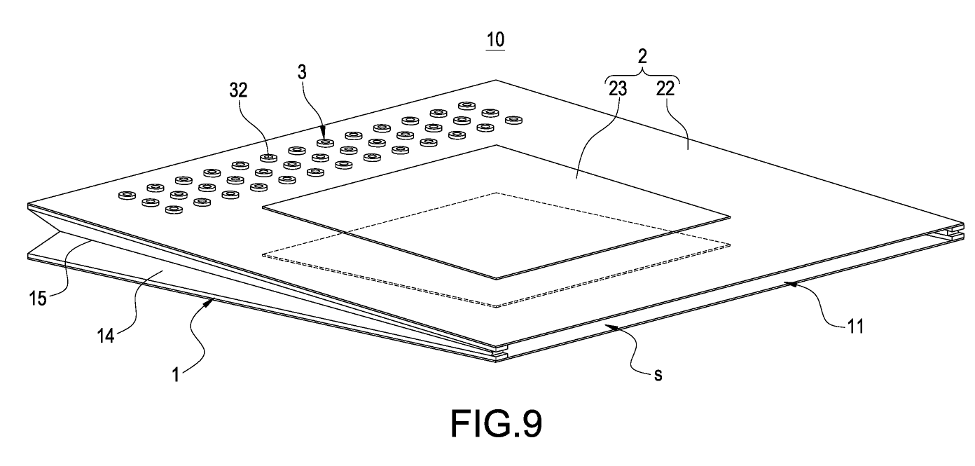

FIG. 9 shows an assembly view of a piezoelectric fan driving device of a third embodiment of the invention. As shown in FIG. 9, the structure of the third embodiment is similar to that of the first embodiment. The difference between the third embodiment and the first embodiment is that the piezoelectric element 2 fails to comprise a membrane 22. As the piezoelectric sheet 23′ fails to comprise a membrane 22, the piezoelectric sheet 23′ has a through hole 21 with a one-way air flowing piece 3 thereon. The piezoelectric sheet 23′ may produce deformation by applying an electric field. A repeated action of the expansion and compression of internal volume of the cavity s is produced to suck a cold air from outside through the opening 11 and exhaust air out of the piezoelectric fan 10 from the through hole 21 by the one-way air flowing piece 3. The heat inside the electronic device can be dissipated effectively.

As the skilled person will appreciate, various changes and modifications can be made to the described embodiments. It is intended to include all such variations, modifications and equivalents which fall within the scope of the invention, as defined in the accompanying claims.

What is claimed is:

1. A piezoelectric fan driving device comprising:
a piezoelectric fan and a driving unit,
wherein the piezoelectric fan comprises:
a connecting piece having an opening and two end surfaces;
two piezoelectric elements fixed on the two end surfaces, and the connecting piece and two piezoelectric elements surrounding to form a cavity, one of the two piezoelectric elements having a through hole connecting to the cavity; and
at least one one-way air flowing piece connecting to the through hole, and
the driving unit electrically connects with the two piezoelectric elements to convert a DC power to an AC power, and the two piezoelectric elements are driven by the AC power.

2. The piezoelectric fan driving device of claim 1, wherein the one-way air flowing piece is a one-way limiting diaphragm.

3. The piezoelectric fan driving device of claim 1, wherein the one-way air flowing piece is a one-way valve.

4. The piezoelectric fan driving device of claim 1, wherein each the two piezoelectric elements comprises a membrane and a piezoelectric sheet, wherein the membrane is fixed on the two end surfaces of the connecting piece, and the piezoelectric sheet is fixed on a central position of the membrane, and the through hole is provided on the membrane or the piezoelectric sheet.

5. The piezoelectric fan driving device of claim 4, wherein the membrane is made of metallic sheet or plastic sheet.

6. The piezoelectric fan driving device of claim 1, wherein the connecting piece has a horizontal rod and two vertical rods extending from two ends of the horizontal rod, and the opening is formed between the two vertical rods, and the two end surfaces are respectively formed on an upper surface and a lower surface of the horizontal rod and the two vertical rods.

7. The piezoelectric fan driving device of claim 1, wherein the connecting piece is U-shape.

8. The piezoelectric fan driving device of claim 1, wherein the connecting piece is a compressive elastomer.

9. The piezoelectric fan driving device of claim 1, wherein the connecting piece is made of rubber or silicone material.

10. The piezoelectric fan driving device of claim 1, wherein the connecting piece has a recess toward inside between the two end surfaces, and the recess has a thickness less than a thickness of the connecting piece.

11. The piezoelectric fan driving device of claim 1, wherein the connecting piece decreases a thickness gradually from two end surfaces to the recess so that the connecting piece has a section being V-shape or U-shape.

12. The piezoelectric fan driving device of claim 1, wherein the driving unit comprises:
a power converter for converting the DC power into AC power; and
a power amplifier connecting with the power converter and two piezoelectric elements, amplifying the AC power output from the power converter to drive the two piezoelectric elements.
